(19) United States
(12) Patent Application Publication
(10) Pub. No.: US 2012/0192875 A1
(43) Pub. Date: Aug. 2, 2012

(54) MOUTHGUARD WITH HOLOGRAM

(76) Inventor: Trevor Scott Small, White Rock (CA)

(21) Appl. No.: 13/019,908

(22) Filed: Feb. 2, 2011

(51) Int. Cl. A61C 5/14

(52) U.S. Cl. 128/861

(57) ABSTRACT

An athlete's mouthguard containing at least one hologram that has been selected for an ability to project or convey various attributes such as wellness, strength, flexibility, focus, endurance, and balance, or other traits to otherwise stabilize and harmonize the user's body. The hologram need not contain a recognizable team insignia or recognizable advertising logo, and indeed the hologram need not necessarily be visible to outsiders when the mouthguard is worn.

### BACKGROUND OF THE INVENTION

1. Field of the Invention

The invention is in the field of sports equipment, wellness, and athletic mouth guards.

2. Description of the Related Art

Although athletes must both physically condition themselves and practice for their particular athletic competition, different athletes are often roughly equivalent in size, strength and amount of practice, and for peak athletic performance, other mental factors, such as self confidence, can be very important. In particular, an athlete's strong belief in his or her wellness, strength, flexibility, focus, endurance, and balance, can often spell the difference between success and failure.

In recent years, at least some members of the athletic community have come to embrace the ability of holograms, carrying various designs, to symbolize or convey these traits. Thus the use of sports/wellness hologram wristbands has become popular.

For example, PowerBalance LLC, Orange County, Calif. has produced the Power Balance™ series of hologram bearing wristbands and pedants. Each wristband or pendant generally carries at least one hologram design caring a holographic design believed to promote some athletic aspects.

Similarly, EFX performance, Inc., Mission Viejo, Calif. produces a line of wristband, anklet, necklace products, foot pack, and adhesive products, also carrying at least one hologram, also believed by a number of star athletes to promote athletic ability.

Additionally EQ, a private company, operates a website eq-love.com that offers both wristbands and cards that contain various holograms, and which also purport to interact with negative ions in a way that promotes athletic performance.

### Mouthguard Technology

Many sports, in particular contact sports, expose the athlete to potential danger of teeth, lip and gum injury, as well as risk of concussion due to force transmitted from the lower jaw to the brain. To minimize this risk, many athletes, particularly in sports such as baseball, basketball, boxing, football, hockey, rugby, skiing, water polo and the like wear mouthguards to both help protect the teeth and reduce the chance of concussion. Such considerations are discussed in the book by Julian Hodges entitled “Mouthguards & Sport Safety: No-Nonsense Resource for Everyone Who Recommends or Should Wear a Mouthguard”, published in 2009 by Good Innovations Pty Ltd., Avalon Australia.

Being generally hidden inside the user's mouth, mouthguards are often considered to be more functional than decorative, and thus are often relatively unadorned. However Spottiswoode, in U.S. Pat. No. 6,321,752, proposed a mouthguard with insignia that is also observable from the front of the mouthguard when the mouthguard is worn by a human wearer.

Similarly Mams, in U.S. Pat. No. 6,494,210, “Method of advertising with a mouthguard”, has proposed use of a rectangular panel attached to the outer surface of the outer wall of a mouthguard that may bear an advertising logo presumably bearing the name of a product or organization who desires to advertise their services.

### BRIEF SUMMARY OF THE INVENTION

The invention is based, in part, upon the insight that athletes who are involved in (contact sports that puts the athlete at higher risk for teeth damage or even potentially life-threatening concussion, have a greater than usual need for extra psychological assurance and support. After all, they are essentially preparing for a modified form of combat. Even athletes engaged in non-contact sports, such as golf, can occasionally encounter situations where mouthguards can be beneficial as well, because such mouthguards can also reduce the incidence of temporomandibular joint (TMJ) disorders and other problems.

The invention is also based, in part, on the additional insight that mouthguards, being one of the last pieces of equipment that such an athlete would put into place before engaging in a potentially dangerous athletic activity, represent an excellent vehicle for conveying this extra psychological assurance and support. Such support can come in the form of holograms that the athlete believes may enhance his or her performance. Such holograms do not have to be made particularly large or prominent, and indeed may be marginally visible or even invisible, yet still convey a beneficial effect to the athlete. In one embodiment, the invention covers mouthguards equipped with one or more holograms designed to provide psychological support for the athlete. These mouthguards may be of a variety of different designs. The holograms, being intended more for the psychological support of the athlete, than any outward physical appearance, need not be visible to the outside world when the mouthguard is worn by the athlete. Further, the hologram or holograms need not convey any insignia or logo useful for advertising purposes.

### BRIEF DESCRIPTION OF THE DRAWINGS

FIG. 1 shows an example of a simple mouthguard with a hologram intended to be worn in a top position not visible through the opening in the wearer's mouth.

FIG. 2 shows an example of an alternative mouthguard design with a hologram intended to be worn on a side position that is also not visible through the opening in the wearer's mouth.

FIG. 3 shows an example of a region of a mouthguard visible through the opening in the wearer's mouth.

### DETAILED DESCRIPTION OF THE INVENTION

Although in some embodiments of the invention, the hologram may carry a recognizable logo, insignia, or symbol; this is not an absolute requirement. In other embodiments of the invention, the hologram may be an abstract pattern, an image not clearly identified with any organization, team, or product, or other type of design.

In one embodiment, the invention may be a mouthguard device, designed to be inserted through the opening of the mouth of a human wearer, often an athlete, and to be worn inside the mouth of the human wearer. This mouthguard will generally have at least one hologram either embedded in, or firmly affixed to, or created on, the surface of the mouthguard (for example by a printing, embossing, etching or other surface alteration process). The hologram-mouth guard combination will be designed so that the hologram will generally not detach from the mouthguard during normal use, nor be destroyed in the process of being worn in the user's mouth during the course of at least one day of normal use.

The hologram may also be directly exposed on the surface of the mouthguard, be protected by a covering, or even completely encased inside the mouthguard. The hologram or holograms will generally be selected to represent one or more attributes such as wellness, strength, flexibility, focus, endurance, and balance or otherwise to stabilize and harmonize with the wearers body. These holograms may comprise abstract two dimensional or three dimensional designs, various symbols and images recognized by at least some segments of the alternative healthcare or athletic community as representing these attributes, or other designs as desired.

Although in some embodiments of the invention, the hologram may be located near the front of the mouthguard so that it is visible to outside observers when the lips and mouth of the mouthguard wearer are partially or totally open, in other embodiments, the requirement to be visible to outside observers when worn is not necessary. Indeed, in some embodiments, the hologram may be embedded in the interior of the mouthguard, and not be visible from the outside at all.

The hologram or holograms may be of any size or shape—e.g. round, oval, square, triangular, rectangular irregularly shaped and so on. Although the hologram may in some embodiments occupy an appreciable amount of the surface of the area of the mouthguard, in other embodiments the hologram may be small, e.g. ½ inches in diameter or even smaller. Even when visible and exposed to the outside world, the hologram does not need to be legible from any great distance, and indeed often will not be legible from a distance of 24 inches or more. The hologram may or may not have a protective film covering.

Mouthguards typically have an overall “U” shape so as to fit into the mouth and follow the natural curve of the jaw. The structure of most mouthguards is such that they have an outer wall, an inner wall, and a bottom wall. The user's teeth usually fit between the outer and inner wall, and the teeth in the top part of the user's jaw fit on top of the bottom wall, while the teeth in the lower part of the user's jaw fit into the bottom of the bottom wall.

Mouthguards may be implemented with a variety of different materials, including composite materials, as exemplified by Kittelsen in U.S. Pat. No. 6,510,852. Mouthguards may also be made of a thermoplastic material that deforms when hot, but then stiffens when cold, thus enabling a user to bite into the mouthguard and produce a form fitting shape. Such materials are often called “boil and bite” mouthguards, as exemplified Brett in U.S. Pat. No. 6,584,978. Mouthguards can also be custom fit or machined to exactly fit the user's mouth as well.

The mouthguards may be of any size, ranging from full size mouthguards for large adults to mini mouthguards for small children. Stock size (one size fits all) mouthguards may also be used.

Examples of suitable mouthguards are taught by Tomotaka Takeda et. Al. in “Mouthguards: The Effects and the Solutions for Underlying Problems”, Nova Science Publishers Inc., 2010, and by Julian Hodges “Mouthguards & Sport Safety: No-Nonsense Resource for Everyone Who Recommends or Should Wear a Mouthguard”, published in 2009 by Good Innovations Pty Ltd., Avalon Australia.

In this specification, the term “hologram” is used in the conventional physics sense to include both transmission and reflection holograms. In a hologram, the image is formed by interference between different light wavefronts, often by light interaction with a series of thin lines on the holograph that are spaced at intervals roughly corresponding to the wavelength of the light source, thus causing interference in a manner not unlike that of a diffraction grating.

Suitable holograms can be made using a wide variety of different materials and a wide variety of different processes. Suitable materials include photographic emulsions, photoresists, photopolymers, photochromics, photothermoplastics photorefractives, elastomers, glass, plastic, metals, metal foils, foils, and the like. The various processes to create holograms include embossing, photographic exposure, chemical etching, electron beams, and even using specially designed holoprinter printer. Typically holograms produce a three dimensional image that varies in appearance and depth as the position of the observer shifts relative to the hologram and the light source. Holograms can be produced by holography of real objects, or they can be computer generated.

Although many different types of holographic designs are suitable for the invention, in a preferred embodiment, those holographic designs that certain elite athletes are willing to give testimonials or references for as being particularly effective will be used. Irrespective of the exact mechanism involved in the interaction between holograms and athletic performance, the power of suggestion alone is often sufficient to make such endorsed designs more efficacious than other designs.

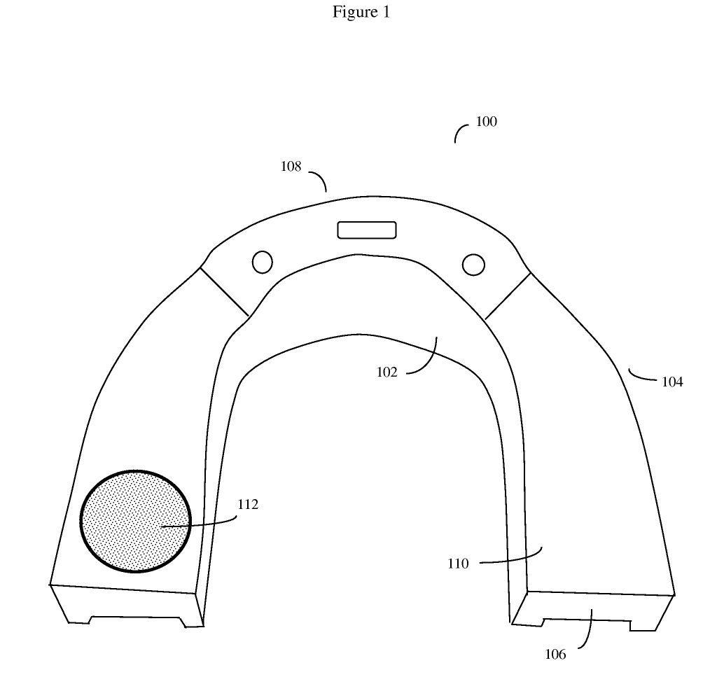

FIG. 1 shows an example of a simple mouthguard (100) seen from above. The mouthguard has an inner wall (102), and outer wall (104), and a bottom wall (106). The front of the mouthguard is shown as (108), and the rear of the mouthguard, where the wearer's molars will fit, is shown as (110). A hologram is positioned on the bottom wall (112). Note that when the mouthguard (100) is worn, this hologram (112) will generally not be seen by outside viewers because outside viewers will only be able to see the front of the mouthguard (108).

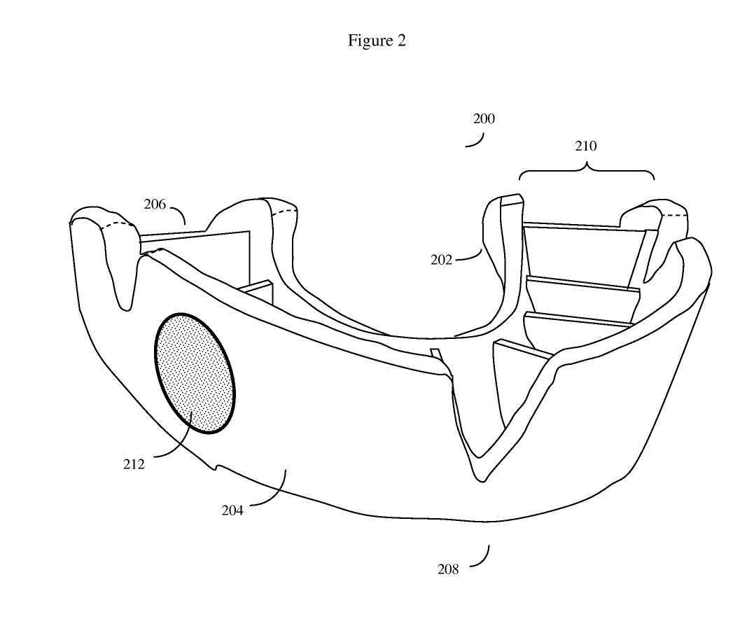

FIG. 2 shows a more complex mouthguard (200) with a somewhat different design, this time from the front perspective. This mouthguard also has an inner wall (202), an outer wall (204) and a bottom wall (206). The front of this mouthguard is shown as (208), and the rear of this mouthguard, where the user's molars will fit, is shown as (210). In this embodiment, the hologram (212) is shown mounted on the outer wall (204).

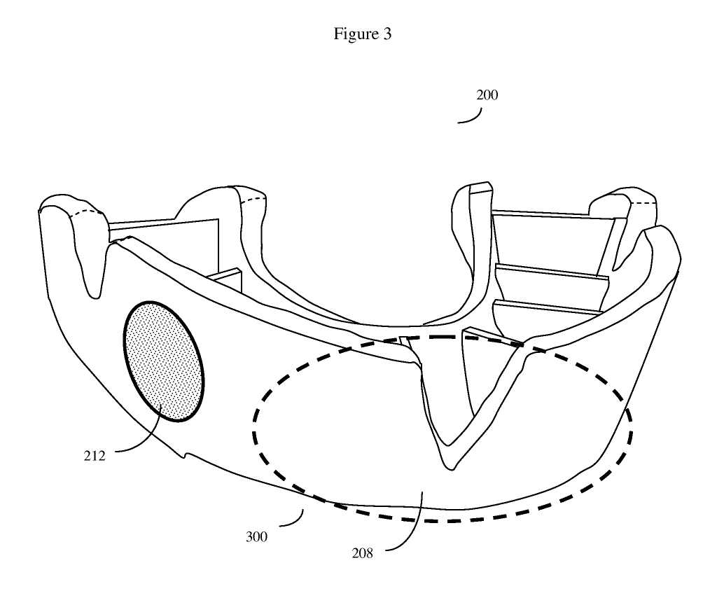

FIG. 3 shows the mouthguard of FIG. 2 (200), this time with an oval (300) showing the approximate maximal opening of the user's mouth when the mouthguard is being worn. As can be seen, only the front of the mouthguard (208) is visible. The structures in the rear of the mouthguard, including hologram (212) will be covered by the user's cheeks, and will thus not be visible.

1. A mouthguard device designed to be inserted through the opening of the mouth of a human wearer and to be worn inside the mouth of said human wearer, said mouthguard device comprising at least one hologram.

2. The device of claim 1, wherein said at least one hologram is visible through the opening of the mouth of said human wearer when said mouthguard is worn inside the mouth of said human wearer.

3. The device of claim 2, wherein said at least one hologram does not contain a recognizable advertising logo visible though the opening of the mouth of said human wearer.

4. The device of claim 1, wherein said at least one hologram is not visible thorough the opening of the mouth of said human wearer when said mouthguard is worn inside the mouth of said human wearer.

5. The device of claim 1, wherein said at least one hologram is selected to represent one or more attributes selected from the group consisting of wellness, strength, flexibility, focus, endurance, and balance or otherwise to stabilize and harmonize said human wearer's body.

6. The device of claim 1, wherein said at least one hologram is visible on the surface of said mouthguard.

7. The device of claim 6, wherein said at least one hologram is visible from the outer surface, inner surface, bottom or top of said mouthguard device.

8. The device of claim 1, wherein said hologram is embedded in the interior of said mouthguard.

9. The device of claim 1, wherein said mouthguard is a composite mouthguard, a boil & bite mouthguard, or a custom fit mouthguard.

10. A mouthguard device, designed to be inserted through the opening of the mouth of a human wearer and to be worn inside the mouth of said human wearer, said mouthguard device comprising at least one hologram;
wherein said at least one hologram is selected to represent one or more attributes selected from the group consisting of wellness, strength, flexibility, focus, endurance, and balance or otherwise to stabilize and harmonize said human wearer's body; and
wherein said at least one hologram does not contain a recognizable advertising logo or team insignia visible though the opening of the mouth of said human wearer.

11. The device of claim 10, wherein said at least one hologram is visible through the opening of the mouth of said human wearer when said mouthguard is worn inside the mouth of said human wearer.

12. The device of claim 10, wherein said at least one hologram is not visible thorough the opening of the mouth of said human wearer when said mouthguard is worn inside the mouth of said human wearer.

13. The device of claim 10, wherein said at least one hologram is visible on the surface of said mouthguard.

14. The device of claim 10, wherein said hologram is embedded in the interior of said mouthguard.

15. The device of claim 10, wherein said mouthguard is a composite mouthguard, a boil & bite mouthguard, or a custom fit mouthguard.

16. A mouthguard device, designed to be inserted through the opening of the mouth of a human wearer and to be worn inside the mouth of said human wearer, said mouthguard device comprising at least one hologram;
wherein said at least one hologram is selected to represent one or more attributes selected from the group consisting of wellness, strength, flexibility, focus, endurance, and balance or otherwise to stabilize and harmonize said human wearer's body; and
wherein said at least one hologram is not visible thorough the opening of the mouth of said human wearer when said mouthguard is worn inside the mouth of said human wearer.

17. The device of claim 16, wherein said at least one hologram is visible on the surface of said mouthguard.

18. The device of claim 17, wherein said at least one hologram is visible from the outer surface, inner surface, bottom or top of said mouthguard device.

19. The device of claim 16, wherein said hologram is embedded in the interior of said mouthguard.

20. The device of claim 16, wherein said mouthguard is a composite mouthguard, a boil & bite mouthguard, or a custom fit mouthguard.
